(19) United States
(12) Patent Application Publication
(10) Pub. No.: US 2025/0043110 A1
(43) Pub. Date: Feb. 6, 2025

(54) POLYOLEFIN RESIN FOAM

(71) Applicant: INOAC CORPORATION, Aichi (JP)

(72) Inventors: Kazuma TAZAWA, Aichi (JP); Yuji KONDO, Aichi (JP); Naoki HASHIMOTO, Gifu (JP)

(73) Assignee: INOAC CORPORATION, Aichi (JP)

(21) Appl. No.: 18/844,476

(22) PCT Filed: Mar. 8, 2023
(86) PCT No.: PCT/JP2023/008803

§ 371 Date: Sep. 6, 2024

(30) Foreign Application Priority Data
Mar. 24, 2022 (JP) 2022-048372

(51) Int. Cl. C08K 11/00

(52) U.S. Cl. CPC C08K 11/005; C08K 2201/005

(57) ABSTRACT

A polyolefin resin foam containing a biomass material containing calcium carbonate as the main component is provided. The polyolefin resin foam can contain the biomass material in an amount of 50% by weight or less. As the biomass material used in the polyolefin resin foam, a biomass material derived from eggshells and/or seashells can be used.

### TECHNICAL FIELD

The present technology relates to a polyolefin resin foam, and more specifically, to a polyolefin resin foam having a biomass degree above a certain level.

### BACKGROUND ART

In recent years, in order to contribute to the formation of a sustainable society, attention has been focused on how to utilize unused biomass, which would otherwise be waste, such as food residue, livestock feces and urine, sewage sludge, and the like, as so-called carbon-neutral renewable resources. Technologies that use biomass materials are being developed also for synthetic resins, which are used in a wide variety of fields such as civil engineering and construction, packaging and wrapping, vehicles, various other miscellaneous goods, and the like.

For example, Patent Literature 1 proposes a resin composition containing 5 to 50 parts by weight of an eggshell powder per 100 parts by weight of a high molecular weight polymer. The resin composition described in Patent Literature 1 is made by recycling eggshells, which are food waste, and using them as a plastic material, so it is environmentally friendly and can reduce material costs.

### CITATION LIST

### Patent Literature

Patent Literature 1: JP 2019-503411 A

### SUMMARY OF INVENTION

### Technical Problem

As mentioned above, a technology for incorporating waste materials such as food residue and the like into synthetic resins is being developed, but, when waste materials such as food residue and the like are incorporated into a foam obtained by foaming a resin composition, there are problems such as reduced foamability and reduced mechanical properties, making it difficult to put the technology into practical use.

Therefore, the main object of the present technology is to provide a high-quality polyolefin resin foam, even though it uses biomass materials.

### Solution to Problem

In the present technology, first, a polyolefin resin foam containing a biomass material containing calcium carbonate as the main component is provided.

The polyolefin resin foam according to the present technology can contain the biomass material in an amount of 50% by weight or less.

As the biomass material used in the polyolefin resin foam according to the present technology, a biomass material derived from eggshells and/or seashells can be used.

As the biomass material derived from eggshells and/or seashells, eggshell powders and/or seashell powders can be used.

In this case, as the eggshell powder and/or seashell powder, the eggshell powder and/or seashell powder that has an average particle size of 8 to 200 μm can be used.

### DESCRIPTION OF EMBODIMENTS

A preferred embodiment for carrying out the present technology will be described below. The embodiments described below are representative examples of the present technology, and any of the embodiments can be combined. In addition, the scope of the present technology is not narrowly interpreted by these.

### 1. Polyolefin Resin Foam

The polyolefin resin foam according to the present technology contains a biomass material containing calcium carbonate as the main component. That is, the polyolefin resin foam according to the present technology is a foam of a resin composition containing a biomass material containing calcium carbonate as the main component. In addition, the resin composition for producing the polyolefin resin foam according to the present technology (hereinafter, also referred to as “the resin composition according to the present technology” or “the resin composition”) may contain a foaming agent, a foaming aid, a crosslinking agent, a crosslinking accelerator, and other various components that can be used in the production of polyolefin resin foams depending on the purpose. Each component will be described in detail below.

### (1) Polyolefin Resin

The polyolefin resin that can be used in the polyolefin resin foam of the present technology is a resin that contains an olefin component unit as the main component. The resin that contains an olefin component unit as the main component is a resin that contains 50% by mass or more of an olefin component unit. In the present technology, the content of the olefin component unit in the resin is preferably 70% by mass or more, more preferably 80% by mass or more, and even more preferably 90% by mass or more, and it is particularly preferable that the resin component is composed only of a polyolefin resin.

Examples of the polyolefin resin that can be used in the present technology include polyethylene resins, polypropylene resins, polybutene, polypentene, and copolymers composed an olefin monomer and a monomer copolymerizable with the olefin monomer, and these can be used alone or in combination of two or more kinds.

Examples of the polyethylene resins include ethylene homopolymers such as high-density polyethylene (HDPE), low-density polyethylene (LDPE), linear low-density polyethylene (LLDPE), very low-density polyethylene (VLDPE), and the like; and ethylene-propylene random copolymers, ethylene-propylene block copolymers, ethylene-butene block copolymers, ethylene-butene random copolymers, ethylene-vinyl acetate copolymers, ethylene-methyl methacrylate copolymers, and the like.

Examples of the polypropylene resins include propylene homopolymers such as isotactic polypropylene, syndiotactic polypropylene, atactic polypropylene, and the like; and propylene-ethylene random copolymers, propylene-ethylene block copolymers, propylene-butene random copolymers, propylene-butene block copolymers, propylene-ethylene-butene terpolymers, propylene-acrylic acid copolymers, propylene-maleic anhydride copolymers, and the like.

Among these, in the present technology, it is preferable to use a polyethylene resin, and among the polyethylene resins, it is preferable to use low-density polyethylene (LDPE) and ethylene-vinyl acetate copolymer.

The melt flow rate (MFR) of the polyolefin resin is not particularly limited as long as it does not impair the operation and effects of the present technology. For example, the melt flow rate (MFR) of low-density polyethylene (LDPE) is preferably 10.0 g/10 min or less, more preferably 5.0 g/10 min or less.

The origin of the polyolefin resin that can be used in the present technology is not particularly limited, and it is not limited to petroleum-derived polyolefin resins, but biomass-derived polyolefin resins can be used. By using a biomass-derived polyolefin resin as the polyolefin resin in addition to biomass materials containing calcium carbonate as the main component, which will be described later, the biomass degree can be further improved.

In addition, in this technology, “biomass-derived polyolefin resin” means one containing a naturally occurring resin component. A specific example is a resin containing a component derived from naturally occurring ethylene. Naturally occurring ethylene can be produced, for example, by fermenting carbohydrates obtained from natural raw materials such as sugarcane using a fermenting agent such as a yeast (e.g., Saccharomyces cerevisiae, etc.) to generate ethanol, and then converting the generated ethanol to ethylene through a catalytic reaction under high temperature conditions (for example, 300° C. or higher) using a catalyst such as gamma alumina, to obtain naturally occurring ethylene, which is a raw material for the naturally occurring polyethylene.

The polyolefin resin foam according to this technology may contain resins other than polyolefin resins, such as other resins or elastomers, to the extent that the purpose and operation and effects of this technology are not impaired, in addition to polyolefin resins. Examples of resins other than polyolefin resins include thermoplastic resins such as polystyrene resins, polyamide resins, polyester resins, and the like. Examples of elastomers other than polyolefin resins include olefin thermoplastic elastomers, styrene thermoplastic elastomers, and the like.

### (2) Biomass Material Containing Calcium Carbonate as Main Component

The biomass material containing calcium carbonate as the main component used in the polyolefin resin foam according to the present technology is a biomass material containing 50% by mass or more of calcium carbonate. In the present technology, the content of calcium carbonate in the biomass material is preferably 70% by mass or more, more preferably 80% by mass or more, and even more preferably 90% by mass or more.

The amount of the biomass material used in the polyolefin resin foam according to the present technology can be freely set as long as the purpose and operation and effects of the present technology are not impaired. In the present technology, the upper limit of the content of the biomass material in the resin composition is, for example, 50% by weight or less, preferably 40% by weight or less, and more preferably 30% by weight or less. By controlling the content of the biomass material in the resin composition to 50% by weight or less, it is possible to suppress a decrease in foamability during foam production and a decrease in physical properties of the foam to be produced.

In the present technology, the lower limit of the content of the biomass material in the resin composition is, for example, 1% by weight or more, preferably 10% by weight or more, more preferably 15% by weight or more, and even more preferably 20% by weight or more. By setting the content of the biomass material in the resin composition to 10% by weight or more, it is possible to improve the biomass degree and contribute to the formation of a sustainable society.

Examples of the biomass materials containing calcium carbonate as the main component used in the present technology include biomass materials derived from eggshells and/or seashells. Examples of the eggshell include eggshells of birds, reptiles, and the like. Examples of the seashell include seashells such as scallops, oysters, surf clams, and the like. Among these, in this technology, eggshells are particularly preferred because they have a low content of alkaline components derived from the ocean, and from the viewpoint of recycling waste such as food residue, etc., and the viewpoint of cost, and because they contain relatively few impurities, it is more preferable to use eggshells from birds such as chickens, etc.

As the biomass material derived from eggshells and/or seashells, it is preferable to use eggshell powders and/or seashell powders. By powdering the eggshells and/or seashells, it is possible to improve the workability during kneading with the resin component and other components described below and the physical properties of the produced foam.

The average particle size of the eggshell powder and/or seashell powder is not particularly limited and can be freely designed according to the application of the foam and the expected physical properties. The lower limit of the average particle size of the eggshell powder and/or seashell powder that can be used in the present technology is, for example, 6 μm or more, preferably 8 μm or more, more preferably 10 μm or more, and even more preferably 13 μm or more. By using the eggshell powder and/or seashell powder with an average particle size of 6 μm or more, the dispersibility in the resin composition during foam production is improved, and it can also contribute to reducing the pulverization cost.

The upper limit of the average particle size of the eggshell powder and/or seashell powder that can be used in the present technology is, for example, 200 μm or less, preferably 100 μm or less, more preferably 50 μm or less, and even more preferably 40 μm or less. By using the eggshell powder and/or seashell powder with an average particle size of 200 μm or less, it is possible to improve the workability when mixing with the resin component and other components described later, and the physical properties of the produced foam.

In the present technology, the term “average particle size” refers to the particle size (D-50) at a cumulative frequency of 50% in the particle size distribution measured by a laser diffraction method.

It is preferable to use a heat-treated biomass material derived from eggshells and/or seashells. Heat treatment can remove protein components and other impurities in the biomass material, so using heat-treated biomass materials derived from eggshells and/or seashells can improve foamability during foam production, and improve the physical properties of the foam to be produced.

### (3) Foaming Agent

The resin composition for producing the polyolefin resin foam according to the present technology can contain a foaming agent. As the foaming agent that can be used in this technology, one or more types of foaming agents that can be used in the polyolefin resin foam may be freely selected and used as long as the purpose and operation and effects of this technology are not impaired.

As the foaming agent that can be used in the present technology, for example, organic or inorganic pyrolyzable chemical foaming agents can be used. Examples of the organic foaming agents include azo compounds such as azodicarbonamide (ADCA), azodicarboxylic acid metal salts (barium azodicarboxylate, etc.), azobisisobutyronitrile (AIBN), etc.: nitroso compounds such as N,N′-dinitrosopentamethylene tetramine (DPT), etc.: hydrazine derivatives such as hydrazodicarbonamide, 4,4′-oxybis (benzenesulfonylhydrazide), toluenesulfonylhydrazide (TSH), etc.; semicarbazide compounds such as toluenesulfonyl semicarbazide, etc.; and the like. Examples of the inorganic foaming agents include ammonium carbonate, sodium carbonate, ammonium hydrogen carbonate, sodium hydrogen carbonate, ammonium nitrite, sodium borohydride, anhydrous monosodium citric acid, and the like.

Among these, in the present technology, it is preferable to use organic foaming agents as the foaming agent, and among the organic foaming agents, it is preferable to use azodicarbonamide (ADCA).

The amount of the foaming agent used in the production of the polyolefin resin foam according to the present technology can be freely set as long as it does not impair the purpose and effects of the present technology. In the present technology, the lower limit of the content of the foaming agent in the resin composition is, for example, 0.5% by weight or more, preferably 1.5% by weight or more, and more preferably 2.5% by weight or more. The amount of the foaming agent to be added to 100 parts by mass of the resin component in the resin composition is, for example, 0.7 parts by mass or more, preferably 2.0 parts by mass or more, and more preferably 4.0 parts by mass or more. By setting the content of the foaming agent in the resin composition to 0.5% by weight or more or 0.7 parts by mass or more relative to 100 parts by mass of the resin component, the foamability during foam production can be improved, and the physical properties of the foam to be produced can be improved.

In the present technology, the upper limit of the content of the foaming agent in the resin composition is, for example, 15% by weight or less, preferably 13% by weight or less, and more preferably 10% by weight or less. The amount of the foaming agent to be added to 100 parts by mass of the resin component in the resin composition is, for example, 25 parts by mass or less, preferably 20 parts by mass or less, and more preferably 15 parts by mass or less. By setting the content of the foaming agent in the resin composition to 15% by weight or less or 25 parts by weight or less relative to 100 parts by weight of the resin component, formation defects due to excessive foaming can be suppressed, and it is possible to contribute to cost reduction.

### (4) Foaming Aid

The resin composition for producing the polyolefin resin foam according to the present technology can contain a foaming aid. As the foaming aid that can be used in the present technology, one or more foaming aids that can be used in the polyolefin resin foam may be freely selected and used as long as the purpose and operation and effects of the present technology are not impaired.

Examples of foaming aids that can be used in the present technology include urea aids such as urea, etc.; metal oxides, and fatty acid metal salts. Examples of the metal oxides include zinc oxide, zinc chloride, zinc acetate, zinc nitrate, lead oxide, dibasic lead phosphite, and tribasic lead sulfate. Examples of the fatty acid metal salts include zinc stearate, lead stearate, magnesium stearate, and calcium stearate. Among these, in the present technology, it is preferable to use zinc oxide as the foaming aid.

The amount of the foaming aid used in the production of the polyolefin resin foam according to the present technology can be freely set as long as it does not impair the purpose or effects of the present technology. In the present technology, the lower limit of the content of the foaming aid in the resin composition is, for example, 0.05% by weight or more, preferably 0.1% by weight or more, and more preferably 0.2% by weight or more. The amount of the foaming aid to be added to 100 parts by mass of the resin component in the resin composition is, for example, 0.1 parts by mass or more, preferably 0.2 parts by mass or more, and more preferably 0.3 parts by mass or more. By setting the content of the foaming aid in the resin composition to 0.05% by weight or more or 0.1 parts by mass or more relative to 100 parts by mass of the resin component, the foamability during foam production can be improved, and the physical properties of the foam to be produced can be improved.

In the present technology, the upper limit of the content of the foaming aid in the resin composition is, for example, 4.0% by weight or less, preferably 3.0% by weight or less, and more preferably 2.5% by weight or less. The amount of the foaming aid to be added to 100 parts by mass of the resin component in the resin composition is, for example, 6.0 parts by mass or less, preferably 4.0 parts by mass or less, and more preferably 3.5 parts by mass or less. By setting the content of the foaming aid in the polyolefin resin foam to 4.0% by weight or less or 6.0 parts by mass or less relative to 100 parts by mass of the resin component, it is possible to suppress formation defects due to excessive foaming, and also to contribute to cost reduction.

### (5) Crosslinking Agent

The polyolefin resin foam according to the present technology may be a non-crosslinked foam or a crosslinked foam. By crosslinking during production of the polyolefin resin foam according to the present technology, it is possible to improve the viscosity of the composition (kneaded material) before foaming and improve foamability. Moreover, the physical properties of the produced foam can be improved.

When the polyolefin resin foam according to the present technology is a crosslinked foam, crosslinking can be performed by irradiation with ionizing radiation, but it can also be chemically crosslinked using a crosslinking agent. As the crosslinking agent that can be used in this technology, one or more crosslinking agents that can be used in polyolefin resin foams may be freely selected and used as long as the purpose and operation and effects of this technology are not impaired.

Examples of the crosslinking agents that can be used in the present technology include crosslinking agents having chemical structures such as a silane group, peroxide, a hydroxyl group, an amide group, an ester group, and the like. Among these, in the present technology, it is preferable to use an organic peroxide as the crosslinking agent.

Examples of the organic peroxides include dicumyl peroxide, 2,5-dimethyl-2,5-di (t-butylperoxy) hexane, 2,5-dimethyl-2,5-di (benzoylperoxy) hexane, 2,5-dimethyl-2,5-di (t-butylperoxy) hexyne-3, di-t-butyl peroxide, di-t-butylperoxy-3,3,5-trimethylcyclohexane, t-dibutyl hydroperoxide, and the like. Among these, in the present technology, it is preferable to use dicumyl peroxide as the crosslinking agent.

The amount of the crosslinking agent used in the production of the polyolefin resin foam according to the present technology can be freely set as long as the purpose and effects of the present technology are not impaired. In the present technology, the lower limit of the content of the crosslinking agent in the resin composition is, for example, 0.1% by weight or more, preferably 0.3% by weight or more, and more preferably 0.4% by weight or more. The amount of the crosslinking agent to be added to 100 parts by mass of the resin component in the resin composition is, for example, 0.2 parts by mass or more, preferably 0.4 parts by mass or more, and more preferably 0.6 parts by mass or more. By setting the content of the crosslinking agent in the resin composition to 0.1% by weight or more or 0.2 parts by mass or more relative to 100 parts by mass of the resin component, the viscosity can be improved to raise the foamability. Furthermore, the heat resistance and the mechanical properties such as durability of the produced foam can be improved.

In this technology, the upper limit of the content of the crosslinking agent in the resin composition is, for example, 3.0% by weight or less, preferably 2.0% by weight or less, and more preferably 1.5% by weight or less. The amount of the crosslinking agent to be added to 100 parts by mass of the resin component in the resin composition is, for example, 4.0 parts by mass or less, preferably 3.0 parts by mass or less, and more preferably 2.0 parts by mass or less. By setting the content of the crosslinking agent in the resin composition to 3.0% by weight or less or 4.0 parts by mass or less relative to 100 parts by mass of the resin component, it is possible to prevent cracks, etc. from occurring during foaming and improve moldability.

### (6) Crosslinking Accelerator

When using a crosslinking agent during production of the polyolefin resin foam according to the present technology, a crosslinking accelerator can also be used for the purpose of promoting crosslinking by the crosslinking agent. As the crosslinking accelerator that can be used in this technology, one or more crosslinking accelerators that can be used in polyolefin resin foams can be freely selected and used as long as the purpose and operation and effects of this technology are not impaired.

Examples of the crosslinking accelerators that can be used in the present technology include triallyl trimellitate, diallyl phthalate, divinylbenzene, trimethylolpropane trimethacrylate, 1,9-nonanediol dimethacrylate, 1,10-decanediol dimethacrylate, triallyl isocyanurate, ethylvinylbenzene, neopentyl glycol dimethacrylate, 1,6-hexanediol dimethacrylate, and the like.

### (7) Other

In the production of the polyolefin resin foam according to the present technology, one or more of various components that can be used in the production of the polyolefin resin foam can be freely selected and used depending on the purpose as other components, as long as the purpose and effects of the present technology are not impaired.

Examples of components that can be used in producing the polyolefin resin foam according to the present technology include inorganic fillers, foam stabilizers, flame retardants, stabilizers, plasticizers, colorants, antioxidants, dispersants, ultraviolet absorbers, and the like.

### (8) Physical Properties of Polyolefin Resin Foam According to Present Technology

### [Biomass Degree]

The biomass degree of the polyolefin resin foam according to the present technology can be freely set as long as it does not impair the operation and effects of the present technology. The lower limit of the biomass degree of the polyolefin resin foam according to the present technology is, for example, 5% or more, preferably 10% or more, more preferably 15% or more, and even more preferably 20% or more. The higher the biomass degree of the polyolefin resin foam according to the present technology, the more environmentally friendly it is, so there is no upper limit to the biomass degree.

### [Density]

The density of the polyolefin resin foam according to the present technology can be freely set as long as it does not impair the operation and effects of the present technology. The lower limit of the density of the polyolefin resin foam according to the present technology is, for example, 30 kg/m³ or more, preferably 40 kg/m³ or more, more preferably 45 kg/m³ or more, even more preferably 50 kg/m³ or more, and particularly preferably 55 kg/m³ or more. The upper limit of the density of the polyolefin resin foam according to the present technology is, for example, 120 kg/m³ or less, preferably 115 kg/m³ or less, more preferably 110 kg/m³ or less, and even more preferably 105 kg/m³ or less.

### [25% Compressive Stress]

The compressive stress of the polyolefin resin foam according to the present technology can be freely set as long as it does not impair the operation and effects of the present technology. The lower limit of the compressive stress of the polyolefin resin foam according to the present technology is, for example, 60 kPa or more, preferably 65 kPa or more, more preferably 70 kPa or more, and even more preferably 75 kPa or more. The upper limit of the compressive stress of the polyolefin resin foam according to the present technology is, for example, 300 kPa or less, preferably 290 kPa or less, more preferably 280 kPa or less, and even more preferably 270 kPa or less.

### [Compression Set]

The compression set of the polyolefin resin foam according to the present technology can be freely set as long as it does not impair the operation and effects of the present technology. The lower limit of the compression set of the polyolefin resin foam according to the present technology is not particularly set, but is usually 0.5% or more. The upper limit of the compression set of the polyolefin resin foam according to the present technology is, for example, 6.5% or less, preferably 6.0% or less, more preferably 5.5% or less, and even more preferably 5.0% or less.

### [Tensile Strength]

The tensile strength of the polyolefin resin foam according to the present technology can be freely set as long as the operation and effects of the present technology are not impaired. The lower limit of the tensile strength of the polyolefin resin foam according to the present technology is, for example, 0.15 MPa or more, preferably 0.20 MPa or more, more preferably 0.25 MPa or more, and even more preferably 0.30 MPa or more. The upper limit of the tensile strength of the polyolefin resin foam according to the present technology is not particularly set, but is usually 3.00 MPa or less.

### [Tensile Elongation]

The tensile elongation of the polyolefin resin foam according to the present technology can be freely set as long as it does not impair the operation and effects of the present technology. The lower limit of the tensile elongation of the polyolefin resin foam according to the present technology is, for example, 30% or more, preferably 50% or more, more preferably 70% or more, even more preferably 90% or more, and particularly preferably 105% or more. The upper limit of the tensile elongation of the polyolefin resin foam according to the present technology is not particularly set, but is usually 500% or less.

### [Heat Shrinkage Rate]

The heat shrinkage rate of the polyolefin resin foam according to the present technology can be freely set as long as the operation and effects of the present technology are not impaired. The lower limit of the heat shrinkage rate of the polyolefin resin foam according to the present technology is not particularly set, but is usually 0.25% or more. The upper limit of the heat shrinkage rate of the polyolefin resin foam according to the present technology is, for example, 3.0% or less, preferably 2.0% or less, more preferably 1.5% or less, and even more preferably 1.1% or less. Note that, in the present technology, “heat shrinkage rate” is heat shrinkage rate that does not limit directions such as vertical, horizontal, up and down, unless otherwise specified.

### [Number of Cells]

The number of cells of the polyolefin resin foam according to the present technology can be freely set as long as the operation and effects of the present technology are not impaired. The lower limit of the number of cells in the polyolefin resin foam according to the present technology is, for example, 55 cells/25 mm or more, preferably 60 cells/25 mm or more, more preferably 65 cells/25 mm or more, and even more preferably 70 cells/25 mm or more. Although the upper limit of the number of cells of the polyolefin resin foam according to the present technology is not particularly set, it is usually 250 cells/25 mm or less.

### 2. Method for Producing Polyolefin Resin Foam

The polyolefin resin foam according to the present technology is characterized by its composition, and its production method is not particularly limited. For example, a method can be adopted in which a foaming agent is added to a polyolefin resin, and then a crosslinking agent and other additives are added and mixed as necessary, and then foaming molding is performed. Preferably, the production method of the polyolefin resin foam can be any of the following one-stage block foaming method, two-stage block foaming method, long-length foaming method using chemical crosslinking, and long-length foaming method using electron beam crosslinking.

### <One-Stage Block Foaming Method>

The one-stage block foaming method includes, for example, the following steps (1) and (2).

### (1) Kneading Step

A polyolefin resin, an eggshell powder, a foaming agent, and as required, a crosslinking agent, a foaming aid, a crosslinking accelerator, and other optional components are melt-kneaded at a temperature below the decomposition temperature of the forming agent in a kneading device such as an extruder, a Banbury mixer, a kneader, a roll, or the like, to obtain a foamable resin composition.

### (2) Foaming Step

The foamable resin composition obtained in the kneading step is filled into a mold, sealed and pressurized, and heated to a temperature higher than the decomposition temperature of the foaming agent and crosslinking agent (if a crosslinking agent is used) for a certain period of time, to progress the decomposition of the foaming agent and the crosslinking agent (if a crosslinking agent is used). Thereafter, the mold is opened and the pressure is removed, to obtain a polyolefin resin foam.

### <Two-Stage Block Foaming Method>

The two-stage block foaming method includes, for example, the following steps (1) to (3).

### (1) Kneading Step

A polyolefin resin, an eggshell powder, a foaming agent, and as required, a crosslinking agent, a foaming aid, a crosslinking accelerator, and other optional components are melt-kneaded at a temperature below the decomposition temperature of the foaming agent in a kneading device such as an extruder, a Banbury mixer, a kneader, a roll, or the like, to obtain a foamable resin composition.

### (2) Primary Foaming Step

The foamable resin composition obtained in the kneading step is filled into a molding space of a primary mold and heated under pressure. This causes a part of the foaming agent and a part or all of the crosslinking agent (if a crosslinking agent is used) to decompose. The pressure is then released and the foamable resin composition intermediate is taken out. The heating temperature is usually 130 to 150° C., and the heating time is usually determined within the range of 25 to 50 minutes.

### (3) Secondary Foaming Step

The foamable resin composition intermediate obtained in the primary foaming step is placed in a molding space of an unsealed secondary mold and heated under normal pressure to cause secondary foaming, after which the resin foam is taken out from the secondary mold.

### <Long-Length Foaming Method Using Chemical Crosslinking>

The long length foaming method includes, for example, the following steps (1) and (2).

### (1) Kneading Step

A polyolefin resin, an eggshell powder, a foaming agent, a crosslinking agent, and as required, a foaming aid, a crosslinking accelerator, and other optional components are kneaded and extruded into a sheet using a single screw extruder, a twin screw extruder, or the like to extrude a foamable resin composition of a predetermined shape such as a sheet (hereinafter, referred to as a mother plate).

The kneading and extrusion can be carried out simultaneously using an extruder.

### (2) Foaming Step

The mother plate obtained in the kneading step is heated and foamed at 120-250° C. (above the decomposition temperature of the foaming agent and crosslinking agent) for 5-20 minutes while being transported into a heating device such as an oven, to obtain a resin foam. Note that it is preferable to use a device in which a heating device such as an oven and a transport device are integrated, since this allows the mother plate to be treated continuously.

### <Long-Length Foaming Method Using Electron Beam Crosslinking>

The long length foaming method using electron beam crosslinking includes, for example, the following steps (1) to (3).

### (1) Kneading Step

A polyolefin resin, an eggshell powder, a foaming agent, and as required, a crosslinking agent, a foaming aid, a crosslinking accelerator, and other optional components are kneaded by a single-screw extruder, a twin-screw extruder, etc., and simultaneously extruded into a resin composition of a predetermined shape such as sheet (hereinafter, referred to as a mother plate). The kneading and extrusion can be carried out simultaneously using an extruder.

### (2) Crosslinking Step

The mother plate obtained in the kneading step is crosslinked. As a crosslinking method, a method of irradiating with ionizing radiation such as an electron beam or gamma ray can be used, and crosslinking by electron beam irradiation (electron beam crosslinking) is preferable.

Electron beam crosslinking can be performed using an electron beam irradiation machine. Note that, if necessary, a crosslinking agent such as the organic peroxide described above may be used in combination.

### (3) Foaming Step

The crosslinked mother plate obtained in the crosslinking step is heated and foamed at 120-250° C. (above the decomposition temperature of the foaming agent) for 5-20 minutes while being transported into a heating device such as an oven, to obtain a resin foam. Note that it is preferable to use a device in which a heating device such as an oven and a transport device are integrated, since this allows the mother plate to be treated continuously.

In the method for producing the polyolefin resin foam according to the present technology described above, other steps can be performed depending on the purpose. For example, after the crosslinking step or the foaming step, a cooling step, an aging step, etc. can be performed. In addition, a molding step such as cutting or slicing the produced foam can also be performed.

### 3. Applications of Polyolefin Resin Foam

The polyolefin resin foam according to the present technology can be used for all kinds of purposes in all fields by taking advantage of its high quality. For example, it can be suitably used for concrete expansion joint materials, concrete formwork, construction joint materials, cushioning materials for construction, sealing materials for construction, sealing materials for home appliances, packaging materials, insulation materials for vehicles, anti-condensation materials, interior materials, insulation materials for home appliances, piping heat insulating materials, various covers, cushioning materials, toys, miscellaneous goods, cleaners, various sponges, toys, beat boards, floats, sports miscellaneous goods, and the like.

Note that the present technology can also have the following configuration.
[1]

A polyolefin resin foam containing a biomass material containing calcium carbonate as the main component.
[2]

The polyolefin resin foam according to [1], containing the biomass material in an amount of 50% by weight or less.
[3]

The polyolefin resin foam according to [1] or [2], wherein the biomass material is derived from eggshells and/or seashells.
[4]

The polyolefin resin foam according to [3], wherein the biomass material is an eggshell powder and/or seashell powder.
[5]

The polyolefin resin foam according to [4], wherein the eggshell powder and/or seashell powder has an average particle size of 8 to 200 μm.

### EXAMPLES

The present technology will be described in more detail below based on examples. Note that the examples described below are representative examples of the present technology, and the scope of the present technology is not to be interpreted narrowly by these examples.

### Experimental Example 1

In Experimental Example 1, a difference in physical properties between the presence or absence of a biomass material containing calcium carbonate as the main component for the polyolefin resin foam produced using the one-stage foaming method was examined.

### (1) Raw Material

Resin component 1: Low-density polyethylene (LDPE) (density: 0.924 g/cm³, MFR: 3.0 g/10 min, petroleum-derived)
Resin component 2: Polyolefin resin (included in foaming agent masterbatch)
Resin component 3: Low-density polyethylene (LDPE) (density: 0.921 g/cm³,

MFR: 1.9 g/10 min, petroleum-derived)
Resin component 4: Low-density polyethylene (LDPE) (density: 0.923 g/cm³, MFR: 2.7 g/10 min, derived from biomass (sugar cane) (biomass degree 95% or more))
Biomass material 1: Eggshell powder (average particle size 15 μm, membrane 70% to 90% treated) (“D-50” 15 μm, manufactured by GreenTechno21 Co., Ltd.)
Biomass material 2: Eggshell powder (average particle size 30 μm, membrane 70% to 90% treated) (“D-50” 30 μm, manufactured by GreenTechno21 Co., Ltd.)
Foaming agent: azodicarbonamide (ADCA)
Crosslinking agent: dicumyl peroxide
Foaming aid: zinc oxide

### (2) Production of Foam

Each foam raw material shown in Table 1 below was kneaded in a kneader, then filled into a mold, heated and pressurized at the temperature shown in Table 1, and then depressurized to cause foaming, thereby producing each foam.

### (3) Evaluation

The produced foams were evaluated for various physical properties using the following methods.

### [Biomass Degree]

The biomass degree was calculated using the following formula.

$$Biomass degree ( \% ) = ( total weight of biomass - derived materials / total weight of raw materials ) \times 100$$

When a biomass-derived resin is used, the “total weight of biomass-derived materials” in the above formula is the total weight of the biomass material containing calcium carbonate as the main component and the biomass-derived resin. Note that the calculation was made assuming that the biomass degree of the resin component 4 was 95%.

### [Density]

The density was measured in accordance with JIS K7222:2005.

### [Compressive Stress] [Compression Set] [Tensile Strength] [Tensile Elongation][Heat Shrinkage]

Compressive stress, compression set, tensile strength, tensile elongation, and heat shrinkage were measured according to JIS K6767:1999.

### [Number of Cells]

The number of cells was determined by counting the number of cells per 2000 μm length using a scanning electron microscope (SEM) at a magnification of 35 times in accordance with JIS K6767:1999, and converting the number to the number per 25 mm.

### [Cell Condition]

The cell condition was evaluated based on the following evaluation criteria.
∘: Uniform cell condition with no pinholes, cracks, blisters, etc.
x: Non-uniform cell condition with pinholes, cracks, blisters, etc.

### (4) Results

The results are shown in Table I below.

TABLE 1

| | | | Example | | | | | | | | | | Comparative example | |
|---|---|---|---|---|---|---|---|---|---|---|---|---|---|---|
| | | | 1 | | 2 | | 3 | | 6 | | 7 | | 1 | |
| | | | parts by | | parts by | | parts by | | parts by | | parts by | | parts by | |
| | | | mass | weight % | mass | weight % | mass | weight % | mass | weight % | mass | weight % | mass | weight % |
| Composition | Resin component | LDPE | 96.5 | 65.9 | 96.5 | 65.9 | 96.5 | 65.9 | — | — | — | — | 96.5 | 88.5 |
| | | (Resin component 1) | | | | | | | | | | | | |
| | | Polyolefin resin | 3.5 | 2.4 | 3.5 | 2.4 | 3.5 | 2.4 | 3.5 | 2.4 | 3.5 | 2.4 | 3.5 | 3.2 |
| | | (Resin component 2) | | | | | | | | | | | | |
| | | LDPE | — | — | — | — | — | — | 96.5 | 65.9 | — | — | — | — |
| | | (Resin component 3) | | | | | | | | | | | | |
| | | LDPE | — | — | — | — | — | — | — | — | 96.5 | 65.9 | — | — |
| | | (Resin component 4) | | | | | | | | | | | | |
| | Biomass material | Eggshell powder | 37.3 | 25.5 | 37.3 | 25.5 | — | — | 37.3 | 25.5 | 37.3 | 25.5 | — | — |
| | containing calcium | average particle | | | | | | | | | | | | |
| | carbonate as the | size 15 um | | | | | | | | | | | | |
| | main component | Eggshell powder | — | — | — | — | 37.3 | 25.5 | — | — | — | — | — | — |
| | | average particle | | | | | | | | | | | | |
| | | size 30 um | | | | | | | | | | | | |
| | Foaming agent | A.D.C.A. | 5.2 | 3.6 | 5.2 | 3.6 | 5.2 | 3.6 | 5.2 | 3.6 | 5.2 | 3.6 | 5.2 | 4.8 |
| | Crosslinking | Dicumyl peroxide | 1.1 | 0.8 | 1.1 | 0.8 | 1.1 | 0.8 | 1.1 | 0.8 | 1.1 | 0.8 | 1.1 | 1.1 |
| | agent | | | | | | | | | | | | | |
| | Foaming aid | Zinc oxide | 2.7 | 1.8 | 2.7 | 1.8 | 2.7 | 1.8 | 2.7 | 1.8 | 2.7 | 1.8 | 2.7 | 2.4 |

| | | | | | | | | | | | | |
|---|---|---|---|---|---|---|---|---|---|---|---|---|
| Total | 146.3 | 100.0 | 146.3 | 100.0 | 146.3 | 100.0 | 146.3 | 100.0 | 146.3 | 100.0 | 109.0 | 100.0 |

| | | | | | | | |
|---|---|---|---|---|---|---|---|
| Production | Primary press temperature | 145° C. | 156° C. | 145° C. | 145° C. | 145° C. | 145° C. |
| conditions | | | | | | | |
| Evaluation | Biomass degree (%) | 25.5 | 25.5 | 25.5 | 25.5 | 88.1 | 0.0 |
| | Density (kg/m³) | 95 | 76 | 95 | 97 | 96 | 70 |
| | Compressive stress (kPa): 10% | 119 | 77 | 115 | 132 | 110 | 78 |
| | Compressive stress (kPa): 25% | 142 | 99 | 140 | 161 | 134 | 100 |
| | Compressive stress (kPa): 50% | 240 | 180 | 235 | 260 | 228 | 182 |
| | Compression set (24 h) % | 2.2 | 3.8 | 2.2 | 3.7 | 2.6 | 2.2 |
| | Tensile strength (MPa) | 1.05 | 1.02 | 1.02 | 1.08 | 0.98 | 1.05 |
| | Tensile elongation (%) | 155 | 120 | 150 | 125 | 150 | 155 |
| | Heat shrink vertical (%) | 1.0 | 0.6 | 1.0 | 1.0 | 0.7 | 0.9 |
| | Heat shrink horizontal (%) | 0.8 | 0.7 | 0.7 | 0.9 | 0.8 | 0.7 |
| | Number of cells (cells/25 mm) | 134 | 138 | 132 | 120 | 119 | 77 |
| | Cell condition | ◯ | ◯ | ◯ | ◯ | ◯ | ◯ |

### (5) Discussion

As shown in Table 1, Examples 1 to 3, 6, and 7 using a biomass material containing calcium carbonate as the main component had the same or better physical properties than Comparative Example 1, which did not use a biomass material. Specifically, the evaluations of compression set, tensile strength, tensile elongation, and heat shrinkage of Examples 1 and 3 using a biomass material containing calcium carbonate as the main component were the same as those of Comparative Example 1, which did not use a biomass material, and the evaluations of compressive stress and the number of cells of Examples 1, 3, 6, and 7 were better than those of Comparative Example 1. From these results, it was confirmed that by using a biomass material containing calcium carbonate as the main component for a polyolefin resin foam, a high-quality foam can be obtained despite its high biomass degree. Furthermore, although Example 2 had the same density as Comparative Example 1, the evaluation of the number of cells of Example 2 was better than that of Comparative Example 1.

In general, when fillers, etc. are added to resin foams, there is a tendency for the physical properties to deteriorate. However, the biomass material containing calcium carbonate as the main component used in this technology performs the function of a filler, etc., but it has been confirmed that the polyolefin resin foam according to this technology using this material has physical properties equal to or superior to those of conventional polyolefin resin foams.

Further, the preferred range of density varies depending on the purpose. For example, in consideration of transportation costs and the like, it may be preferable to have a lower density, but there is generally a problem in that when a resin foam contains a filler or the like, the density increases. On the other hand, when some kind of operation was performed to lower the density, physical properties etc. tended to deteriorate. However, when comparing Example 2 and Comparative Example 1, it was confirmed that Example 2 had the same density as Comparative Example 1, though it contains a biomass material containing calcium carbonate as the main component, which functions as a filler or the like, and the material had physical properties equivalent to or better than those of Comparative Example 1.

### Experiment Example 2

In Experimental Example 2, differences in physical properties were investigated depending on the presence or absence of a biomass material containing calcium carbonate as the main component and the case of use of calcium carbonate as an inorganic substance powder, for the polyolefin resin foam produced by the two-stage foaming method.

### (1) Raw Material

Resin component 5: Low-density polyethylene (LDPE) (density: 0.924 g/cm³, MFR: 1.9 g/10 min, petroleum-derived)
Resin component 6: Low-density polyethylene (LDPE) (density: 0.927 g/cm³, MFR: 3.0 g/10 min, petroleum-derived)
Inorganic powder: calcium carbonate (average particle size 20 μm)

The other raw materials used were the same as those in Experimental Example 1 described above.

### (2) Production of Foam

Each foam raw material shown in Table 2 was kneaded in a kneader, then filled into a mold, heated and pressurized at 130 to 150° C., and then depressurized to cause primary foaming, to prepare each primary foam. Next, each prepared primary foam was placed in an unsealed mold and heated at 150 to 170° C. to cause secondary foaming, to produce each foam.

### (3) Evaluation

The produced foams were evaluated for various physical properties in the same manner as in Experimental Example 1.

### (4) Results

The results are shown in Table 2 below.

TABLE 2

| | | | Example | | | | | | | | | | Comparative example | | | | | |
|---|---|---|---|---|---|---|---|---|---|---|---|---|---|---|---|---|---|---|
| | | | 4 | | 5 | | 8 | | 9 | | 10 | | 2 | | 3 | | 4 | |
| | | | parts by | | parts by | | parts by | | parts by | | parts by | | parts by | | parts by | | parts by | |
| | | | mass | weight % | mass | weight % | mass | weight % | mass | weight % | mass | weight % | mass | weight % | mass | weight % | mass | weight % |
| Com- | Resin | LDPE | 93.7 | 63.0 | 93.7 | 63.0 | — | — | — | — | — | — | 93.7 | 84.2 | 93.7 | 63.0 | — | — |
| position | component | (Resin | | | | | | | | | | | | | | | | |
| | | component 1) | | | | | | | | | | | | | | | | |
| | | Polyolefin resin | 6.3 | 4.2 | 6.3 | 4.2 | 6.3 | 4.2 | 6.3 | 4.2 | 6.3 | 4.2 | 6.3 | 5.7 | 6.3 | 4.2 | 6.3 | 5.7 |
| | | (Resin | | | | | | | | | | | | | | | | |
| | | component 2) | | | | | | | | | | | | | | | | |
| | | LDPE | — | — | — | — | 93.7 | 63.2 | — | — | — | — | — | — | — | — | — | — |
| | | (Resin | | | | | | | | | | | | | | | | |
| | | component 5) | | | | | | | | | | | | | | | | |
| | | LDPE | — | — | — | — | — | — | 93.7 | 63.2 | — | — | — | — | — | — | — | — |
| | | (Resin | | | | | | | | | | | | | | | | |
| | | component 6) | | | | | | | | | | | | | | | | |
| | | LDPE | — | — | — | — | — | — | — | — | 93.7 | 63.2 | — | — | — | — | 93.7 | 84.6 |
| | | (Resin | | | | | | | | | | | | | | | | |
| | | component 4) | | | | | | | | | | | | | | | | |
| | Biomass | Eggshell powder | 37.5 | 25.2 | — | — | 37.5 | 25.3 | 37.5 | 25.3 | 37.5 | 25.3 | — | — | — | — | — | — |
| | material | average particle | | | | | | | | | | | | | | | | |
| | containing | size 15 um | | | | | | | | | | | | | | | | |
| | calcium | Eggshell powder | — | — | 37.5 | 25.2 | — | — | — | — | — | — | — | — | — | — | — | — |
| | carbonate | average particle | | | | | | | | | | | | | | | | |
| | as the | size 30 um | | | | | | | | | | | | | | | | |
| | main | | | | | | | | | | | | | | | | | |
| | component | | | | | | | | | | | | | | | | | |
| | Inorganic | Calcium | — | — | — | — | — | — | — | — | — | — | — | — | 37.5 | 25.2 | — | — |
| | powder | carbonate | | | | | | | | | | | | | | | | |
| | Foaming | A.D.C.A. | 9.5 | 6.4 | 9.5 | 6.4 | 9.5 | 6.4 | 9.5 | 6.4 | 9.5 | 6.4 | 9.5 | 8.5 | 9.5 | 6.4 | 9.5 | 8.6 |
| | agent | | | | | | | | | | | | | | | | | |
| | Crosslinking | Dicumyl | 1.3 | 0.9 | 1.3 | 0.9 | 0.8 | 0.5 | 0.7 | 0.5 | 0.7 | 0.5 | 1.3 | 1.2 | 1.3 | 0.9 | 0.8 | 0.7 |
| | agent | peroxide | | | | | | | | | | | | | | | | |
| | Foaming aid | Zinc oxide | 0.4 | 0.3 | 0.4 | 0.3 | 0.6 | 0.4 | 0.6 | 0.4 | 0.6 | 0.4 | 0.4 | 0.4 | 0.4 | 0.3 | 0.4 | 0.4 |

| | | | | | | | | | | | | | | | | |
|---|---|---|---|---|---|---|---|---|---|---|---|---|---|---|---|---|
| Total | 148.7 | 100.0 | 148.7 | 100.0 | 148.4 | 100.0 | 148.3 | 100.0 | 148.3 | 100.0 | 111.2 | 100.0 | 148.7 | 100.0 | 110.7 | 100.0 |

| | | | | | | | | | |
|---|---|---|---|---|---|---|---|---|---|
| Eval- | Biomass degree (%) | 25.2 | 25.2 | 25.3 | 25.3 | 85.3 | 0.0 | 0.0 | 80.4 |
| uation | Density (kg/m³) | 64 | 64 | 76 | 77 | 74 | 63 | 76 | 65 |
| | Compressive stress (kPa): 10% | 79 | 78 | 100 | 116 | 121 | 150 | 45 | 111 |
| | Compressive stress (kPa): 25% | 94 | 94 | 131 | 133 | 139 | 160 | 70 | 126 |
| | Compressive stress (kPa): 50% | 171 | 171 | 214 | 221 | 221 | 230 | 147 | 196 |
| | Compression set (24 h) % | 4.9 | 4.8 | 2.2 | 4.2 | 3.9 | 3.4 | 4.3 | 2.6 |
| | Tensile strength (MPa) | 0.36 | 0.36 | 0.70 | 0.53 | 0.66 | 0.70 | 0.33 | 0.64 |
| | Tensile elongation (%) | 108 | 107 | 131 | 126 | 132 | 300 | 146 | 259 |
| | Heat shrink vertical (%) | 0.8 | 0.9 | 0.7 | 0.5 | 0.9 | 0.9 | 0.9 | 0.9 |
| | Heat shrink horizontal (%) | 0.9 | 0.8 | 0.8 | 0.8 | 1.0 | 0.5 | 0.8 | 1.0 |
| | Number of cells (cells/25 mm) | 75.0 | 74.0 | 128.0 | 134.0 | 126.0 | 156.0 | 74.0 | 138.0 |
| | Cell condition | ◯ | ◯ | ◯ | ◯ | ◯ | ◯ | ◯ | ◯ |

### (5) Discussion

As shown in Table 2, Examples 4, 5, and 8 to 10 using a biomass material containing calcium carbonate as the main component had physical properties equivalent to those of Comparative Example 2, which did not use a biomass material, and had physical properties equivalent to or better than those of Comparative Example 3, which used calcium carbonate as an inorganic substance powder. Specifically, the evaluations of tensile strength, heat shrinkage, and the number of cells of Examples 4 and 5 using a biomass material containing calcium carbonate as the main component were equivalent to those of Comparative Example 3, which used calcium carbonate as an inorganic substance powder, and the evaluation of compressive stress of Examples 4 and 5 was better than that of Comparative Example 3. It was also found that the evaluations of tensile strength and the number of cells could be improved by changing the type of resin component as in Examples 8 and 9. Furthermore, when Example 10 using a biomass-derived resin component was compared with Comparative Example 4, Example 10 using a biomass material containing calcium carbonate as the main component had physical properties equivalent to those of Comparative Example 4, despite having a higher biomass degree. From these results, it was confirmed that by using a biomass material containing calcium carbonate as the main component in a polyolefin resin foam, a high-quality foam can be obtained despite having a high biomass degree.

Furthermore, from these results, it was confirmed that even when produced using the two-stage foaming method, the polyolefin resin foam according to the present technology has physical properties equivalent to or superior to those of general polyolefin resin foams that do not use biomass materials.

1. A polyolefin resin foam comprising:
a biomass material derived from eggshells in an amount of 40% by weight or less.

2. The polyolefin resin foam according to claim 1, further comprising: an eggshell powder with an average particle size of 6 μm or more.

3. The polyolefin resin foam according to claim 1, wherein the biomass material is in an amount 15% to 40% by weight,
a density of the polyolefin resin foam is 30 to 120 kg/m3.

4-5. (canceled)

6. An article in which the polyolefin resin foam according to claim 1 is used, wherein the article is concrete expansion joint materials, concrete formwork, sealing materials for home appliances, insulation materials for vehicles, anti-condensation materials, insulation materials for home appliances, miscellaneous goods, cleaners, sponges, toys, beat boards, or floats.
